(19) United States
(12) Patent Application Publication
(10) Pub. No.: US 2014/0141661 A1
(43) Pub. Date: May 22, 2014

(54) ELECTRICAL CONTACT ELEMENT

(71) Applicant: Andreas Veigel, Lenningen (DE)

(72) Inventor: Andreas Veigel, Lenningen (DE)

(21) Appl. No.: 14/115,504

(22) PCT Filed: May 6, 2011
(86) PCT No.: PCT/EP2011/002258

§ 371 Date: Nov. 4, 2013

(51) Int. Cl. H01R 13/02

(52) U.S. Cl. CPC H01R 13/02
USPC 439/884

(57) ABSTRACT

Electrical contact element for mechanical introduction into an accommodating opening, provided therefor, in a component mount, which electrical contact element has a contact part wound from electrically conductive connecting wire, which contact part comprises at least two complete wire turns so as to form a substantially cylindrical contact accommodating area which is open on both sides, for accommodating an electrical connection pin of a component to be connected to the contact element, said connection pin having a plurality of outer edges provided for contact-making.

### 1. FIELD OF THE INVENTION

The invention relates to an electrical contact element according to the preamble of claim 1 and to a contact assembly according to claim 11. More particularly, the invention relates to an electrical contact element and a contact assembly for inserting into one or more recesses of a component support, the electrical contact element comprising a contact-receiving space for electrically connecting a connector pin preferably of an electrical component or device to be connected.

### 2. PRIOR ART

In many applications, in particular in the operation of stationary and/or mobile pieces of electrical apparatus or equipment, a large number of different electrical and/or mechanical connections are necessary to both mechanically arrange the equipment in the required position on a support element and to produce an electrical connection between the power supply and the equipment.

In the most general terms, within the meaning of this invention, electrical equipment is understood to be for example electric lights, components, subassemblies, devices and other electrically operated pieces of apparatus, which, in one way or another, are intended to be electrically connected to a power supply or an on-board power supply, or also to each other.

Furthermore, it should be taken into account that subassemblies or pieces of equipment often have to be arranged so as to be spatially separate from each other and in many cases, the connection technologies and solutions used then become limited in technological and economic terms.

For example, rigid printed circuit boards already cannot be used universally due to their geometry. In the case of motor vehicle lights or fittings, for example, which are often designed to have complex and curved geometric shapes and in different planes, printed circuit boards can only be used in limited cases or can no longer be used at all. If, alternatively, flexible solutions are favoured, such as flexible printed circuit boards (flex printed circuits), soldered connections are generally the connection technology used, the technology also being restricted thereto, which, however, is often to be avoided. Furthermore, an additional component support is required since a further problem which arises is the spatial positioning or mechanical arrangement of the electrical components. For this purpose, separate mechanical support elements or, in general terms, component supports, to which the components can be attached, are required in addition to the flexible printed circuit board.

A typical connection technology used in conjunction with printed circuit boards is press-fit technology. DE 198 31 672 A1 and DE 197 26 856 C1 disclose contact elements consisting of a punched bent part, in particular made of a copper alloy. The contact elements are press-fit elements having various plug geometries or contact geometries so as to be able to electrically connect to blade contacts, contact regions of a printed circuit board, contacts of a plug-and-socket connection or to the core of a cable. The contact elements are attached by press-fitting into a press-fit region of a printed circuit board. One or more openings having a substantially circular cross section are introduced into the contact supports, typically by means of drilling. Special feedthrough sleeves are then inserted into the openings, and the press-fit pins of the contact press-fit elements are later inserted into the contact sleeves, as described for example in DE 198 31 672 A1.

Punched grids are an alternative thereto; however, these require tools which are individually adapted to the respective application. Subsequent or later changes in the product development cannot be managed flexibly and lead to high tool costs. DE 102004006575 A1 discloses for example contact elements which are press-fitted into a metal punched grid. The drawback here is that the contact surfaces, in particular in punched grids which have thin walls, are too small to transmit high currents and also a high mechanical stability is not achieved.

An additional typical connection technology for example for arranging and connecting spaced-apart pieces of electrical equipment and electrical components involves the arrangement and mechanical attachment to a component support and the electrical connection by means of plug-and-socket connections.

However, with all connection technologies, environmental influences, temperature fluctuations and corrosion must be taken into account, all of which can lead to problems and technical failure, in particular at exposed points of the automobile. In general, plug-and-socket connections each comprise at least one male contact and one female contact which is pluggable thereto, in which one of the two contact partners is generally designed as a spring-loaded contact. The disadvantages of and the problems which arise from such “contact partners which only contact in a spring-loaded manner” and the resulting non-gas-tight connections are sufficiently described in the prior art.

An additional problem known from the prior art results from the large number of different applications, for example from the large number of models in the automobile sector, which also require a correspondingly high number of different installation situations and connection solutions, but which are, however, undesirable. In order to obtain a simplified assembly, it is necessary to use solutions which are as uniform as possible, or even standardised; in any case, the aim is a reduction in the number of types.

The additional disadvantages which arise in high current applications and when the current load is increased, in particular how they become apparent in high-current on-board power supplies in motor vehicles, are sufficiently described in the prior art.

Therefore, the object of the present invention is to overcome the above-mentioned disadvantages and to create a universally applicable connection arrangement which is reliable both mechanically and electrically and can be used in complex, in particular geometrically complex, installation situations.

The object is achieved by the invention set out in the claims, an electrical contact element being provided for mechanical introduction into a receiving opening provided therefor in a component support, in a substrate or in a mechanical support plate, the contact element forming a contact part which is wound from electrically conductive connection wire, preferably commercially available wire, which contact part comprises at least two complete turns of wire, the turns of wire forming a substantially cylindrical contact-receiving space which is open on both sides, and namely for receiving a connector pin in the contact-receiving space. In this context, the connector pin comprises a plurality of outer edges which are provided for contacting, for contacting the contact element and namely at a plurality of connection points of the single-piece contact part.

The electrical contact element can also comprise a plurality of turns of wire or windings in general, the adjacent turns of wire in each case being designed to rest closely together. The contact-receiving space of a contact element according to the invention has a substantially circular cross section having an inner diameter D₁ for receiving a connector pin, preferably a rectangular or square contact pin having an outer diameter slightly larger than the inner diameter D₁ of the contact-receiving space. This ensures that, when in particular a solid connector pin is introduced, in the contact element, the material is deformed and/or a cold-welding takes place and a gas-tight connection is thus created between the outer edges of the pin and the connection points.

According to the invention, both an electrical contact element “per se” for a connector pin according to the invention and a connection consisting of the contact element and the connector pin are provided. The condition that the outer dimension of the connector pin between two outer edges, which are provided for contacting, should be selected to be larger than the inner diameter of the contact-receiving space D₁ is solved according to the invention in that a pin which is provided or to be inserted preferably comprises a plurality of, preferably four, contact edges along the plugging direction of the connector pin, which edges are arranged in relation to each other such that the distance between two edges, preferably between each two (diametrically) opposed edges, is selected to be larger than the inner diameter D₁.

The outer edges of the pin, which are provided for contacting (also referred to as contact edges in the following), extend preferably over the entire height of the contact-receiving space of the contact part and here contact the contact element at a plurality of (internal) connection points.

The contact element or contact elements can for example be produced directly from a roll of wire by means of an automated manufacturing process. In this context, a wire having an outer diameter D_{WIRE} is wound around a tool, preferably a tool pin, having an outer diameter D₁, and is namely wound with two or more turns.

The wire contact elements according to the invention are configured for insertion into a substantially cylindrical opening or recess provided therefor in a component support, and this insertion can also take place mechanically. In this way, the contact elements can be interconnected in isolation or on the wire, thus as one piece, such that, in an advantageous embodiment, entire contact assemblies can be formed comprising a plurality of interconnected contact elements which are spatially separated from each other and shaped from wire.

A further advantage of the invention is its suitability for an automated assembly process. Namely it is possible to use the writing CNC process to produce contact elements and the necessary connections (wire connections) between the contact elements in one piece and to introduce said elements into complex component supports or into the recesses provided therefor in a complex component support without the need for an electrical conducting path on or in the component support or for an additional cable connection.

By selecting the suitable wire material, wire thickness and tool pin diameter, contact elements having the desired inner and outer diameter can be produced variably and according to the application, which elements can be adapted to the size of the pin to be connected or the connection geometry of a connector pin without costly changes to the tool.

In an advantageous embodiment, the connector pin is designed as a press-fit pin. In any case, the geometry of a contact pair should be adapted such that the connector pin, when it is introduced into the contact element or the contact-receiving space thereof, enters into a gas-tight, preferably a cold-welded, connection, and namely between the contact edges of the connector pin and the inner part of the contact-receiving space of the contact part, which space is wound from wire.

In an advantageous manner, this occurs by means of a connector pin comprising a contact portion which has a higher material strength in relation to the contact part and has a rectangular or square cross section, and namely in the region in which the electrical and mechanical connection to the contact element is intended to be produced.

In a particularly advantageous embodiment, the outer edges of the contact pin, which are provided for contacting the contact element, comprise edge radii R which can represent for example stamped or drawn edges. In this context, edge radii R of approximately 0.08 mm are to be considered to be particularly suitable in the connection geometries which typically occur in practice.

The contact element according to the invention can also be formed from a wire having an insulating casing. The casing is then slit and/or displaced or stripped as intended at the wire connection points when the edges of the connector pin are introduced, while said casing remains undamaged in the other regions and thus a contact assembly which is safe to touch and insulating can be created without any additional measures. This also makes it possible for the wires to be installed economically in a crossover. Moreover, selecting the wire geometry leads to an additional degree of freedom; for example, round wire or flat wire can be used.

Furthermore, an electrical contact assembly is proposed comprising at least two, preferably a plurality of, interconnected contact elements produced from a common connection wire, as described previously. More particularly, an electrical contact assembly is also proposed comprising at least two, preferably a plurality of, interconnected contact elements produced from a common connection wire, as described previously, some or all of the contact elements being connected to or being able to be connected to a corresponding connector pin.

Advantageously, a contact pin comprises a tapered tip. Further advantages, aims and details of the invention are described in the following by way of example, but not by way of a limitation, with reference to the drawings, in which:

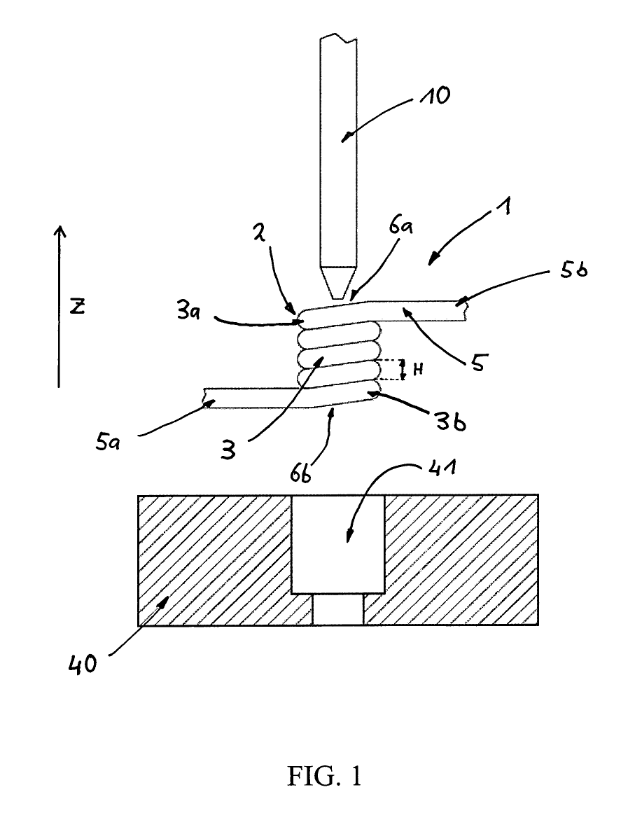

FIG. 1 is a side view of a first embodiment of a contact element in the unconnected state above a component support;

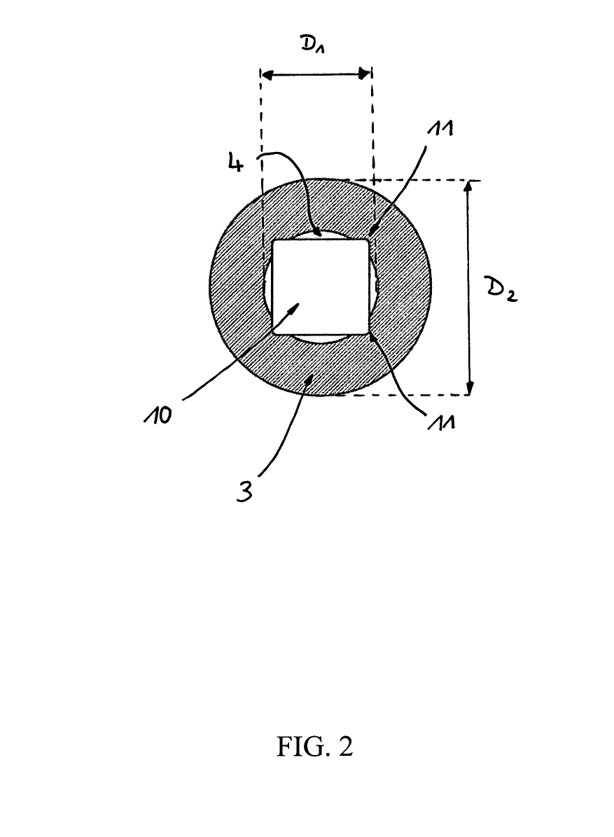

FIG. 2 is an exemplary view of a contact element and a connector pin arranged thereabove;

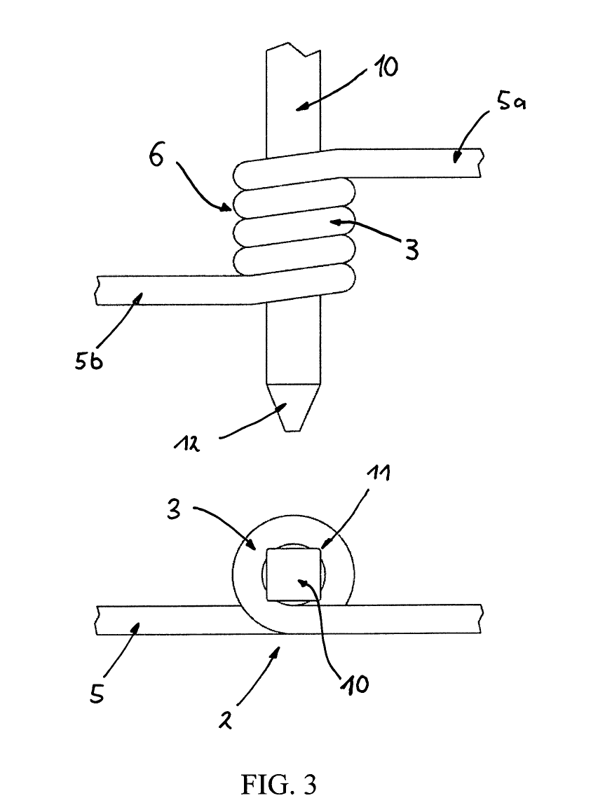

FIG. 3 is a view similar to FIG. 1 in the connected state without a component support;

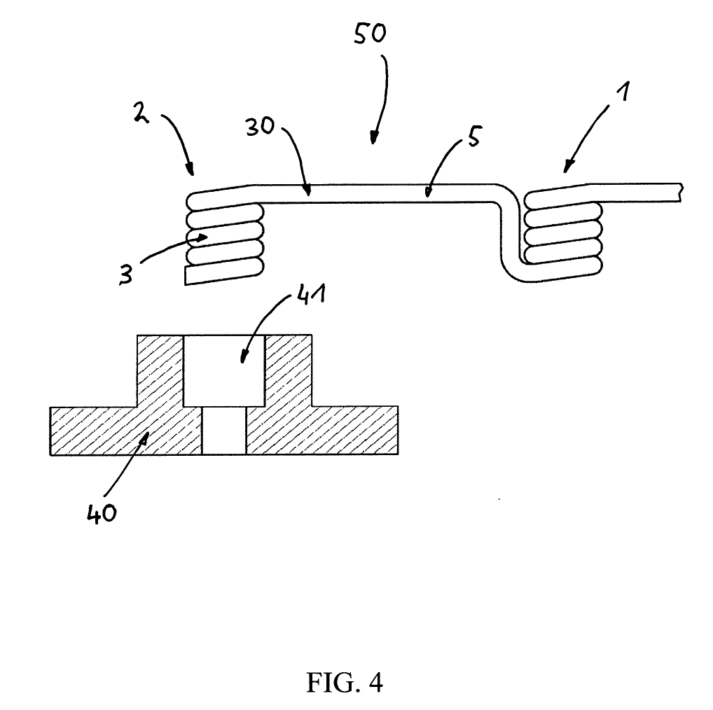

FIG. 4 shows a contact arrangement consisting of two interconnected contact elements, the left contact element being arranged above a component support; and

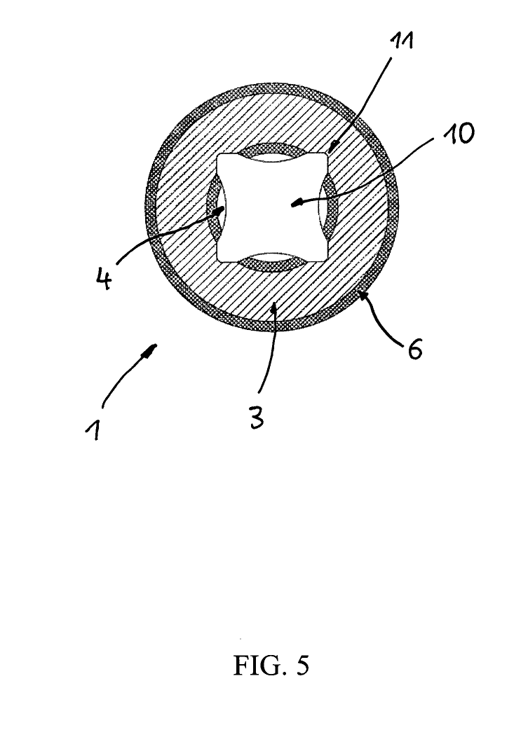

FIG. 5 shows a further embodiment of a connection arrangement according to the invention between a contact element and an additional connector pin shape.

FIG. 1 is a side view of a first embodiment of a contact element 1 having a connector pin 10 arranged thereabove in the unconnected state above a component support 40 having a receiving opening 41. The contact element 1 has a contact part 2 wound from wire 5, which contact part forms a substantially cylindrical contact-receiving space 4 which is open on both sides. The contact-receiving space 4 therefore has an upper opening 6a and a lower opening 6b which are formed and limited by the uppermost and lowermost turn of wire 3a, 3b respectively.

The present embodiment shows a contact part 2 wound from four complete turns of wire 3, 3a, 3b, which contact part is wound helically from wire. The contact part 2 has a pitch H, the pitch H representing the distance by which the helix winds upwards (in the cylinder axis direction Z) in one complete rotation of the wire 5. If the pitch H corresponds to the wire diameter D_{WIRE}, each two adjacent turns of wire 3, 3a, 3b, as shown in FIGS. 1 and 3, rest on each other and form a contact-receiving space 4 which is closed by the wire casing 6 in the casing region. Here, one complete turn of wire 3, 3a, 3b is understood to be when the wire is wound about 360°, as described previously.

As shown in a rudimentary manner in FIGS. 1 and 3, the wire pieces 5a, 5b can lead to adjacent contact parts 2 or can be produced as one piece therewith and connected thereto. This also allows contact elements 1 to be freely introduced into component supports, which are spatially separated from each other, in the space and thus, if appropriate, by the wire 5 being deflected and bent multiple times at the points, provided therefor, in component supports 40.

A connector pin 10 which is suitable for the contact-receiving space 4 of the contact part 2 is further shown in FIG. 1. The connector pin 10 is advantageously designed to have a tapered pin tip 12. FIG. 2 shows an exemplary view of a turn of wire 3 of the contact part 2 of a contact element 1 with a connector pin 10 having a square cross section arranged thereabove.

The contact-receiving space 4 of the contact element 2 has a substantially circular cross section having an inner diameter D₁. The connector pin 10 shown here has four outer edges 11 extending in the plugging direction, which edges are also denoted as contact edges 11 in the following. The outer dimension of the connector pin 10, that is to say the distance between two opposite contact edges 11, is designed to be slightly larger than the inner diameter D₁ of the contact-receiving space 4. When an in particular solid connector pin 10 is introduced, as shown in FIG. 3, the contact edges 11 are materially deformed and/or cold-welded to the contact points of the contact element 2 which creates a gas-tight connection between the outer edges 11 of the pin and the connection points in the contact element 2.

The outer edges 11 of the pin, which are provided for contacting, preferably extend over the entire height of the contact-receiving space 4 of the contact part 2 and are provided with radii, as can be seen in FIG. 2. In the connected state, each turn of wire 3, 3a, 3b is thus contacted by the contact edges 11. The contact part 2 has an outer diameter D₂. Changing the diameter of the wire D_{WIRE} and the inner diameter D₁ of the contact element 2 makes it possible to form a plurality of different contact elements 1.

FIG. 4 shows a contact assembly 50 consisting of two interconnected contact elements 1 made from a common wire 5. According to the invention, contact assemblies 50 can also be formed in a complex manner and can for example also be formed from insulated wire.

FIG. 5 shows a further embodiment of a connection arrangement according to the invention between a contact element and a further connector pin shape according to the invention which corresponds thereto. It can be seen here that the outer edges of the specially shaped connector pin penetrate the insulating casing of the contact element 1.

### List of Reference Signs

1 Contact element
2 Contact part wound from wire
3 Turns of wire
3a, b Upper and lower turn of wire
4 Contact-receiving space
5 Wire
5a, b Wire pieces
6 Wire casing
6a, 6b Upper and lower opening
10 Connector pin
11 Outer edges (contact edges)
12 Pin tip
20 Component
30 Connection wire
40 Component support
41 Receiving opening
50 Contact arrangement
D1 Inner diameter
D2 Outer diameter
D_{WIRE} Diameter of the wire
H Pitch
Z Cylinder axis

1. Electrical contact element (1) for mechanical introduction into a receiving opening (41) provided therefor in a component support (40), which support comprises a contact part (2) wound from electrically conductive connection wire (30), which part has at least two complete turns of wire (3, 3a, 3b) forming a substantially cylindrical contact-receiving space (4) which is open on both sides for receiving an electrical connector pin (10) of a component (20) to be connected to the contact element (1), said pin comprising a plurality of outer edges (11) which are provided for contacting.

2. Electrical contact element (1) according to claim 1, characterised in that adjacent turns of wire (3, 3a, 3b) are in each case designed to rest closely together.

3. Electrical contact element (1) according to either claim 1 or claim 2, characterised in that the contact-receiving space (4) has an inner diameter D₁ for receiving a connector pin (10), which diameter is smaller than the distance between at least two outer edges (11) of the connector pin (10), which are provided for contacting, so as to produce a gas-tight, preferably cold-welded connection between the connector pin (10) and the contact part (2) and namely when the connector pin (10) is introduced into the contact-receiving space (4) as intended.

4. Electrical contact element (1) according to any of the preceding claims, characterised in that the connector pin (10) is a press-fit pin.

5. Electrical contact element (1) according to any of the preceding claims, characterised in that the connector pin (10) comprises a contact portion (12) having a rectangular or square cross section for electrically connecting to the contact part (2).

6. Electrical contact element (1) according to any of the preceding claims, characterised in that the outer edges (11) of the connector pin (10), which are provided for contacting, are provided with edge radii R.

7. Electrical contact element (1) according to any of the preceding claims, characterised in that the connection wire (30) comprises an electrically insulating casing.

8. Electrical contact element (1) according to any of the preceding claims, which further comprises at least one connector pin (10).

9. Electrical contact element (1) according to any of the preceding claims, wherein the outer edges (11) of the connector pin (10), which are provided for contacting, comprise edge radii having a radius of approximately 0.08 mm.

10. Electrical contact element (1) according to any of the preceding claims, characterised in that the connection wire (30) is a round wire or a flat wire.

11. Electrical contact assembly (50) comprising at least two interconnected contact elements (1), according to any of claims 1 to 10, produced from a common connection wire (30).

12. Electrical contact assembly (50) according to claim 11, which comprises at least one connector pin (10).
